(19) United States
(12) Patent Application Publication
(10) Pub. No.: US 2012/0268656 A1
(43) Pub. Date: Oct. 25, 2012

(54) LIGHTING DEVICE, DISPLAY DEVICE AND TELEVISION RECEIVER

(75) Inventor: Yuya Takano, Osaka-shi (JP)

(73) Assignee: SHARP KABUSHIKI KAISHA, Osaka-shi, Osaka (JP)

(21) Appl. No.: 13/517,101

(22) PCT Filed: Dec. 13, 2010
(86) PCT No.: PCT/JP2010/072340

§ 371 Date: Jun. 19, 2012

(30) Foreign Application Priority Data
Dec. 28, 2009 (JP) 2009-297730

(51) Int. Cl. H04N 5/44; F21V 8/00; F21V 7/00; F21V 5/04; F21V 5/02

(52) U.S. Cl. 348/725; 362/606; 362/607; 362/602; 348/E05.096

(57) ABSTRACT

In a backlight unit, light from a light source is easily transmitted to a surface of a light guide plate opposite to a light entrance surface. A backlight unit 24 of the present technology includes an LED unit 32, a light guide plate 20 having a light entrance surface 20a on the side surface thereof and a light collecting member 38. The light collecting member 38 is provided between the LED unit 32 and the light entrance surface 20a and collects light from the LED unit 32 in a thickness direction of the light guide plate 20. The light collecting member 28 directs light from the LED unit 32 to the light entrance surface 20a effectively. Furthermore, the light collecting member 28 prevents light entering from the light entrance surface 20a from being dispersed in the thickness direction of the light guide plate 20 therein. Accordingly, light from the LED unit 32 is likely to be totally reflected within the light guide plate 20.

### TECHNICAL FIELD

The present invention relates to a lighting device, a display device and a television receiver.

### BACKGROUND ART

In recent years, a type of an image display device including a television receiver has been shifted from a conventional CRT display device to a thin display device using a thin display element such as a liquid crystal panel and a plasma display, and a thin image display device is made possible. A liquid crystal panel used for a liquid display device does not emit light, and thus a backlight unit is required as a separate lighting device.

An edge-light type backlight unit is known as a backlight unit in which light sources are arranged on the side surface of a light guide plate. In such an edge-light type backlight unit, light sources are arranged on only one side surface (on only a light entrance surface) of a light guide plate in order to reduce manufacturing cost of light sources. In this case, light entering from the light entrance surface is totally reflected within the light guide plate and travels to a surface opposite to the light entrance surface. Light that is not totally reflected leaks out of the light guide plate and this causes loss of light. Therefore, to obtain sufficient brightness, it is required to direct light from the light sources to a surface of the light guide plate opposite to the light entrance surface thereof.

Patent Document 1 discloses an edge-light type backlight unit in which a light source is arranged on only one side surface of a light guide plate. The backlight unit includes the light source, the light guide plate and a light antireflection film. The light guide plate has a light entrance surface on only one side surface and the light entrance surface faces the light source. The light antireflection film is provided between the light source and the light guide plate. The light antireflection film controls the amount of light that is reflected by the light entrance surface and returned to the light source side. Therefore, the amount of light entering the light guide plate is increased.

Patent Document 1: Japanese Unexamined Patent Publication No. H8-106010

### Problem to be Solved by the Invention

However, in the backlight unit in Patent Document 1, the traveling direction of rays of light traveling toward the light entrance surface is not fixed, and thus rays of light are dispersed widely in the vicinity of the light entrance surface. Accordingly, light that enters the light guide plate from the light entrance surface cannot be effectively transferred to the surface that is opposite to the light entrance surface.

### DISCLOSURE OF THE PRESENT INVENTION

The present invention was accomplished in view of the above circumstances. It is an object of the present invention to provide technology of easily transmitting light emitted from a light source to a surface of a light guide plate that is opposite to a light entrance surface thereof in an edge-light type backlight unit in which the light source is arranged only one side surface of the light guide plate. Another object of the present invention is to provide display device having the lighting device and a television receiver having the display device.

### Means for Solving the Problem

To solve the above problem, a lighting device of the present invention includes a light source, a light guide plate having a light entrance surface on a side surface thereof and a light collecting member provided between the light source and the light entrance surface and configured to collect light from the light source in the thickness direction of the light guide plate.

In the lighting device, the light collecting member collects light from the light source in the thickness direction of the light guide plate. Therefore, light from the light source is directed to the light entrance surface of the light guide plate effectively. Furthermore, light from the light source passes through the light collecting member to fix the traveling direction of light substantially perpendicular to the light entrance surface of the light guide plate. This prevents light that enters the light entrance surface of the light guide plate from being dispersed within the light guide plate in the thickness direction thereof. Thus, light from the light source is likely to be totally reflected within the light guide plate and the light from the light source is easily transmitted to the surface of the light guide plate that is opposite to the light entrance surface thereof.

In the lighting device, the light guide plate may have a light exit surface and an opposite surface. The light exiting from the light source and entering the light entrance surface may be exited through the light exit surface and the opposite surface may be a surface of the light guide plate oppose to the light exit surface. The light collecting member may collect light such that light collected by the light collecting member and entering the light guide plate from the light entrance surface totally reflects off an interface between the light exit surface and another part or an interface between the opposite surface and an outside. With such a configuration, by adjusting light paths of rays of light, light from the light source is likely to be totally reflected within the light guide plate effectively. As a result, light emitted from the light source is easily transmitted to a surface that is opposite to the light entrance surface effectively.

In the lighting device, the light collecting member may include a board and a lens sheet portion, and the board may be formed in a plate shape and provided to face the light source, and the lens sheet portion may be configured by a lens sheet and face the light entrance surface. With such a configuration, by putting the board portion and the lens sheet portion together, the light collecting member can be easily manufactured.

In the lighting device, the light entrance surface may be formed in an elongated shape. The lens sheet portion may be configured with a lenticular lens or a prism lens projecting toward the light guide plate in a convex manner. The lenticular lens or prism lens may have a cylindrical axis extending in the long-side direction of the light entrance surface. With such a configuration, light exiting from the light collecting member to the light entrance surface is allowed to be diffused in the thickness direction of the light guide plate. This directs light from the light source to a broader area of the light entrance surface.

In the lighting device, the prism lens may have a curved top end portion. With such a configuration, if the surface of the lens sheet portion comes in contact with the light entrance surface of the light guide plate due to vibration and the like, the light entrance surface can be prevented from being damaged by the top portions of the prism lenses.

In the lighting device, the lens sheet portion may be configured with a lens array including a plurality of micro lenses each projecting toward the light guide plate in a convex manner. With such a configuration, light exits from a plurality of micro lenses toward the light guide plate, and therefore, light from the light source is directed to the light entrance surface effectively.

In the lighting device, each of the micro lenses may be formed in a pyramid shape. With such a configuration, light from the light source substantially vertically enters the light entrance surface, and the light from the light source is likely to be totally reflected within the light guide plate.

In the lighting device, each of the micro lenses may be formed in a hemispherical shape such that each of the micro lenses is curved in the convex manner so as to project toward the light guide plate. With such a configuration, light exiting from the light collecting member to the light entrance surface is allowed to be diffused in a broad area.

The lighting device may further include a holding member configured to hold at least the light source and the light guide plate and the holding member may include a fitting portion extending in the long-side direction of the light entrance surface, to which the board is fitted. The light collecting member may be fixed by the holding member by fitting of the board to the fitting portion. With such a configuration, the light collecting member is fixed to the fixing grooves formed with the holding members. Therefore, the light collecting member is arranged stably.

The lighting device may further include a reflection member provided between the light source and the light guide plate. The reflection member may extend in the long side direction of the light entrance surface. With such a configuration, light that is dispersed from the light source outside the light collecting member and light that is reflected at the light reflection portion in the light collecting member enter the light collecting member through the reflection member. Furthermore, light dispersed from the light collecting member outside the light guide plate is directed to the light guide plate. This improves the efficiency in directing light emitted from the light source to the light guide plate.

In the lighting device, the lens sheet portion may include a plurality of lens portions provided on a surface of the board close to the light guide plate. The light collecting member may further include a light reflection portion provided between the board and the lens portion, and the light reflection portion may be selectively arranged in a boundary portion between adjacent lens portions. With such a configuration, a part of the light that exits from the light source toward the light collecting member is reflected by the light reflection portion of the board portion and apart of light passes through the board portion. Light reflected at the light reflection portion is reflected by the reflection member to travel toward the light collecting member again. This allows all the light that enters the light collecting member to pass through the lens portions to exit the light guide plate, thereby improving the collimation of light exiting from the light collecting member.

The lighting device may further include a lens member covering a light emission side of the light source. The light source may be a planer light source and the lens member may be formed in a hemispherical shape so as to be curved projecting toward the light collecting member in a convex manner. With such a configuration, light emitted from the light source to the light collecting member can be diffused in a broad area.

The technology disclosed in the present invention may be described as a display device including a display panel configured to provide display using light from the lighting device. Furthermore, a display device configured to provide the display panel that is a liquid crystal panel using liquid crystal may be new and useful. Furthermore, a television receiver including the display device may be new and useful. The display device and the television receiver realize a large display area.

### Advantageous Effect of the Invention

According to the technology disclosed in the specification, in an edge-light type backlight unit in which the light source is arranged only one side surface of the light guide plate, light from the light source is transmitted easily to a surface of the light guide plate that is opposite to a light entrance surface thereof.

### BRIEF DESCRIPTION OF THE DRAWINGS

FIG. 1 is an exploded perspective view illustrating a general configuration of a television receiver TV according to a first embodiment of the present invention;

FIG. 2 is a vertical sectional view illustrating a liquid crystal display device 10;

FIG. 3 is a sectional view illustrating a part of the liquid crystal display device 10;

FIG. 4 is an enlarged perspective view illustrating a light collecting member 38;

FIG. 5 is an enlarged perspective view illustrating a light collecting member 48 according to a second embodiment;

FIG. 6 is an enlarged perspective view illustrating a light collecting member 58 according to a third embodiment;

FIG. 7 is an enlarged perspective view illustrating a light collecting member 68 according to a fourth embodiment;

FIG. 8 is an enlarged perspective view illustrating a light collecting member 78 according to a fifth embodiment;

FIG. 9 is an enlarged perspective view illustrating a light collecting member 88 according to a sixth embodiment;

FIG. 10 is an exploded perspective view illustrating a liquid crystal display device 110 according to a seventh embodiment;

FIG. 11 is a vertical sectional view illustrating the liquid crystal display device 110 according to the seventh embodiment;

FIG. 12 is a sectional view illustrating a part of a backlight unit 124 according to the seventh embodiment; and

FIG. 13 is an enlarged side view illustrating a light collecting member 138.

### BEST MODE FOR CARRYING OUT THE INVENTION

### First Embodiment

A first embodiment of the present invention will be described with reference to drawings. An X axis, a Y-axis and a Z-axis are described in apart of the drawings, and a direction of each axial direction corresponds to a direction described in each drawing. A Y-axis direction matches a vertical direction and an X-axis direction matches a horizontal direction. Unless otherwise noted, a top to bottom direction will be explained based on a vertical direction.

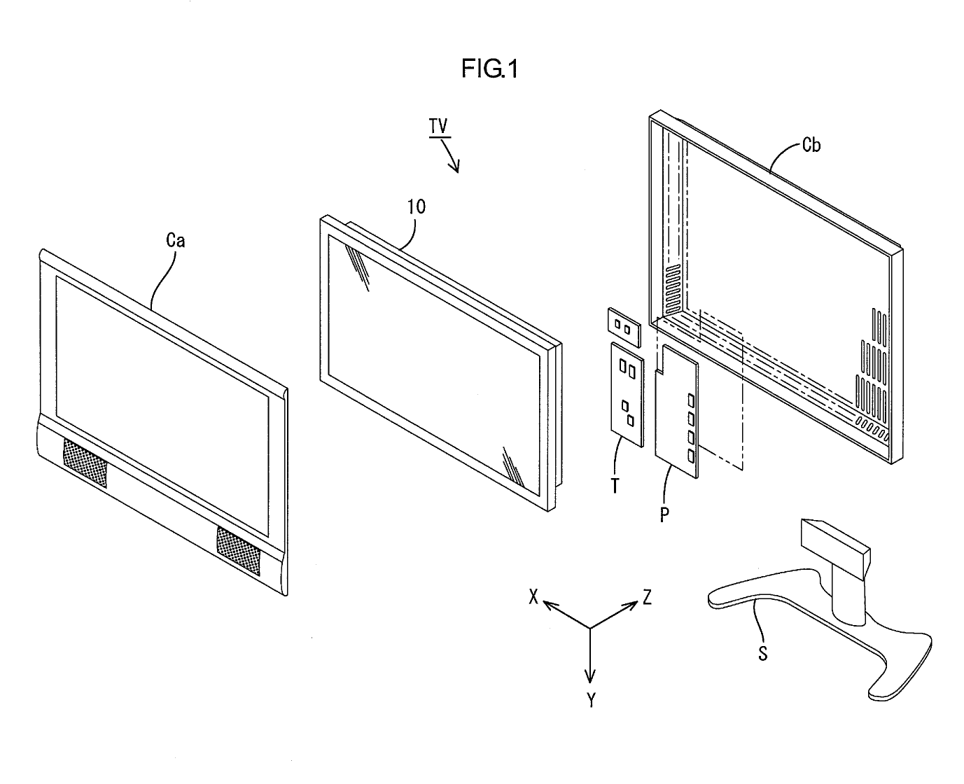

FIG. 1 illustrates an exploded perspective view of a television receiver TV according to a first embodiment of the present invention. As illustrated in FIG. 1, the television receiver TV includes the liquid crystal display device 10, front and rear cabinets Ca, Cb which house the liquid crystal display device 10 therebetween, a power source P, a tuner T and a stand S.

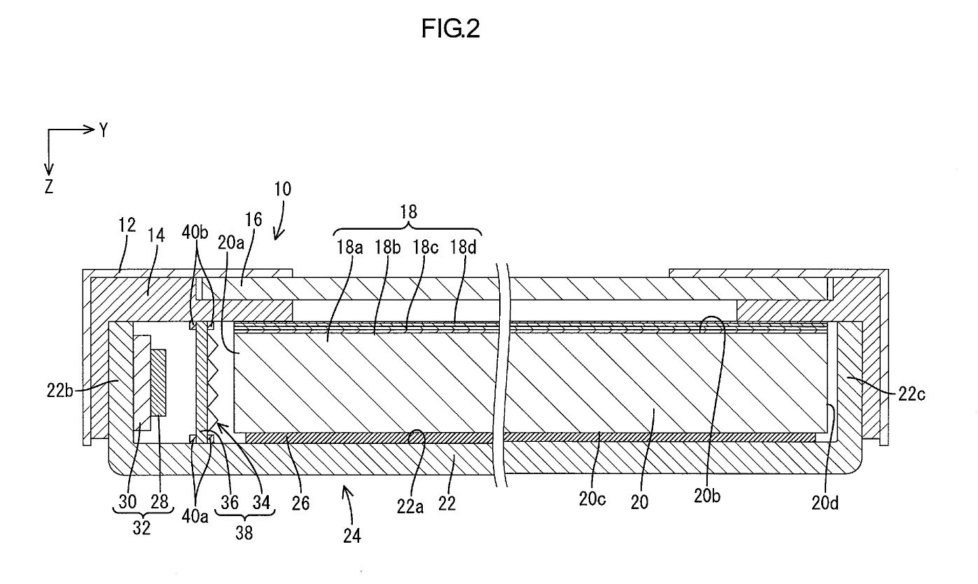

FIG. 2 schematically illustrates a vertical sectional view of the liquid crystal display device 10. An upper side in FIG. 2 corresponds to a front-surface side and a lower side in FIG. 2 corresponds to a rear-surface side. As illustrated in FIG. 2, an entire shape of the liquid crystal display device 10 is a landscape rectangular. The liquid crystal display device 10 includes a liquid crystal panel 16 as a display panel, and a backlight unit 24 as an external light source. The liquid crystal panel 16 and the backlight unit 24 are integrally held by a frame shaped bezel 12 and the like.

Next, the liquid crystal panel 16 will be described. The liquid crystal panel 16 is configured such that a pair of transparent (having highly capable of light transmission) glass substrates is bonded together with a predetermined gap therebetween and a liquid crystal layer (not shown) is sealed between the glass substrates. On one of the glass substrates, switching components (for example, TFTs) connected to source lines and gate lines which are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. Polarizing plates are attached to outer surfaces of the substrates. A drive circuit board (not shown) supplies the source lines, the gate lines and counter electrodes with image data and various control signals that are necessary to display images. Polarizing plates (not shown) are attached to outer surfaces of the substrates.

The backlight unit 24 will be described. As illustrated in FIG. 2, the backlight unit 24 includes a backlight chassis 22, optical members 18 and a front chassis 14. The backlight chassis 22 is formed in a substantially box shape opened to the front surface side (the light exit side and the liquid crystal panel 16 side). The optical members 18 are arranged on the front surface side (a light exit surface 20a side) of a light guide plate 20. The frame-shaped frame 14 supports the liquid crystal panel 16 along an inner periphery of the frame 14. Furthermore, an LED (light emitting diode) unit 32, the light guide plate 20, and a light collecting member 38 are arranged within the backlight chassis 22. The LED unit 32 is provided in one of long-side outer edge portions 22b of the backlight chassis 22 and emits light. One of side surfaces 20a (a light entrance surface) of the light guide plate 20 is provided at a position facing the light collecting member 38. Light exits from the LED unit 32 and passes through the light collecting member 38. The side surface 20a guides the light to the liquid crystal panel 16 side. The optical members 18 are arranged on the front-surface side of the light guide plate 20. In the present embodiment, an edge-light type backlight unit is used for the backlight unit 24. In the backlight unit 24, the light guide plate 20 and the optical members 18 are provided directly below the liquid crystal panel 16 and the LED unit 32 as a light source is provided at the side edge of the light guide plate 20. The light collecting member 38 is provided between the LED unit 32 and the light entrance surface 20a of the light guide plate 20. The light collecting member 38 collects light that exits from the LED unit 32 and collects the light in the thickness direction of the light guide plate 20. In the following, the light collecting member 38 will be explained in detail with reference to other drawings.

The backlight chassis 22 is made of metal such as aluminum material. The backlight chassis 22 includes a rectangular bottom plate 22a in a plan view and side plates 22b and 22c each of which rises from an outer edge of the corresponding side of the bottom plate 22a toward the front-surface side. The backlight chassis 22 houses the light guide plate 20 in a space opposite to the LED unit 32. A power supply circuit board (not shown) configured to supply power to the LED unit 32 is mounted on the rear side of the bottom plate 22a.

The optical members 18 include laminated layers of a diffuser plate 18a, a diffuser sheet 18b, a lens sheet 18c and a reflecting type polarizing sheet 18d in this order from the light guide plate 20 side. The diffuser sheet 18b, the lens sheet 18c and the reflecting type polarizing sheet 18d have a function for making planar light from light exiting from LED unit 32 and transmitting the diffuser plate 18a therethrough. The liquid crystal panel 16 is provided on the front surface side of the reflecting type polarizing sheet 18d. The optical members 18 are provided between the light guide plate 20 and the liquid crystal panel 16.

The light guide plate 20 formed in a rectangular plate shape is made from a resin highly capable of light transmission (or with high clarity) such as acrylic. The backlight chassis 22 supports the light guide plate 20. As illustrated in FIG. 2, the light guide plate 20 is provided between the light collecting member 38 and the side plate 22c of the backlight chassis 22. The light exit surface 20b as a main plate surface is provided to face the diffuser plate 18a. A light reflection sheet 26 is provided on a surface 20c (opposite surface) of the light guide plate 20 that is opposite to a surface thereof facing the diffuser plate 18a. The light reflection sheet 26 reflects light that leaks out of the light guide plate 20 and returns the light to the light guide plate 20. With such a configuration, light generated from the LED unit 32 passes through the light collecting member 38 and then enters the light entrance surface 20a of the light guide plate 20 and exits from the light exit surface 20b facing the diffuser plate 18a. Accordingly, the light radiates the liquid crystal panel 16 from the rear side thereof.

The LED unit 32 includes a rectangular LED board 30 and LED light sources 28. The LED board 30 is made from resin. A plurality of LED light sources 28 configured to emit white light are arranged linearly along the long-side of the light guide plate 20. The LED light sources 28 face the light collecting member 38. The LED unit 32 is mounted on the long-side outer edge portion 22b of the backlight chassis 22 with screws and the like such that the LED light sources 28 face the light collecting member 38.

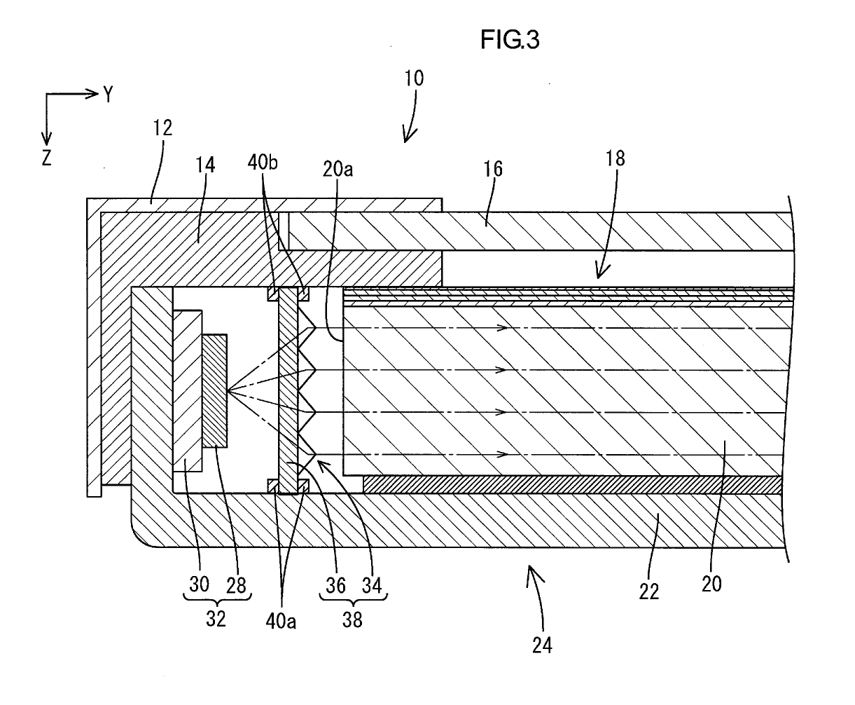

FIG. 3 illustrates a sectional view of a part of the liquid crystal display device 10. FIG. 3 illustrates an enlarged sectional view of the vicinity of the light collecting member 38. Dash-dotted arrows in FIG. 3 represent light paths of rays of light emitted from the LED light source 28. As illustrated in FIG. 3, rays of light emitted from the LED light source 28 are collected in the thickness direction of the light guide plate 20 through the light collecting member 38, and enter the light guide plate 20 so as to be substantially perpendicular to the light entrance surface 20a of the light guide plate 20. The light collecting member 38 is configured to collect light such that light enters the light guide plate 20 and totally reflects off an interface between the light exit surface 20b and the diffuser plate 18a or an interface between the opposite surface 20c and the reflection sheet 26.

The light collecting member 38 includes a board portion 36 and a lens sheet portion 34. An upper edge portion and a lower edge portion of the board portion 36 are fitted to fitting portions 40a and 40b, respectively. One fitting portion 40b is provided on the surface of the frame 14 so as to extend in the long-side direction of the light guide plate 20. The other fitting portion 40a is provided on the surface of the backlight chassis 22 so as to extend in the long-side direction of the light guide plate 20.

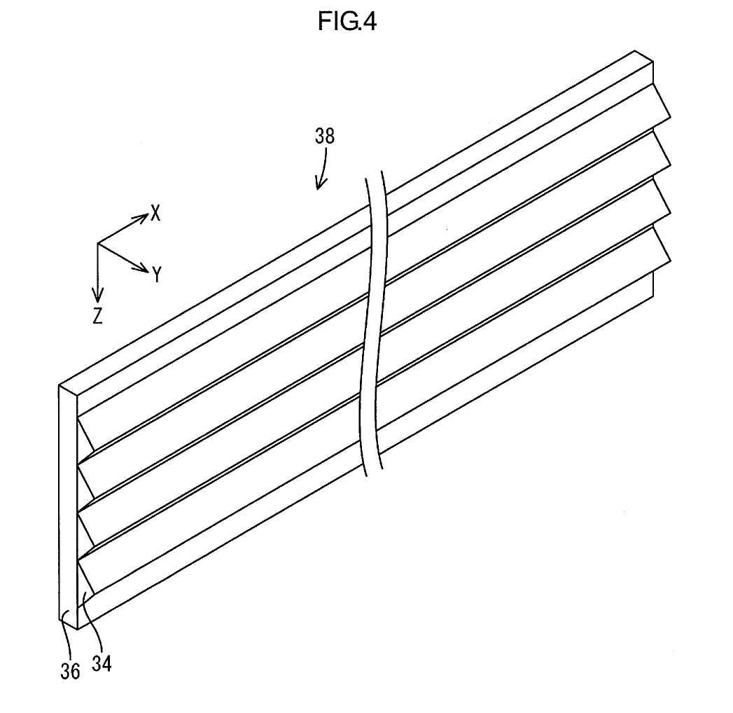

FIG. 4 illustrates an enlarged perspective view of the light collecting member 38. As illustrated in FIG. 4, the plate-shaped board portion 36 facing the LED unit 32 extends in the long-side direction (X-axis direction) of the light guide plate 20. The board portion 36 is made from a transparent material. The lens sheet portion 34 facing the light entrance surface 20a is configured with prism lenses projecting toward the light guide plate 20 in a convex manner. The prism lens is formed in an elongated shape and a cylinder axis of prism lens extends in the long-side direction of the light entrance surface 20a. The board portion 36 and the lens sheet portion 34 are put together to be integrally formed as the light collecting member 38.

The television receiver TV of the present embodiment has been described in detail. In the backlight unit 24 of the television receiver TV according to the present embodiment, the light collecting member 38 is configured to collect light from the LED unit 32 in the thickness direction of the light guide plate 20, and accordingly, light from the LED unit 32 is effectively directed to the light entrance surface 20a of the light guide plate 20. Furthermore, light from the light sources passes through the light collecting member 38 to fix the traveling direction of the light to be substantially perpendicular to the light entrance surface 20a of the light guide plate 20. This prevents light that enters the light entrance surface 20a of the light guide plate 20 from being dispersed within the light guide plate 20 in the thickness direction thereof. Therefore, light from the LED unit 32 is likely to be totally reflected within the light guide plate 20 and is easily transmitted to a surface 20d (see FIG. 2) of the light guide plate 20 that is opposite to the light entrance surface 20a thereof.

In the present embodiment, the light collecting member 38 is configured to collect light such that the light enters the light guide plate 20 and totally reflects off an interface between the light exit surface 20b and the diffuser plate 18a or an interface between the opposite surface 20c and the reflection sheet 26. Accordingly, light from the LED unit 32 is likely to be totally reflected within the light guide plate 20. Therefore, light from the LED unit 32 is easily transmitted to the surface 20d that is opposite to the light entrance surface 20a.

In the present embodiment, the light collecting member 38 includes the board portion 36 and the lens sheet portion 34. The light collecting member 38 is easily manufactured by putting the board portion 36 and the lens sheet portion 34 together.

In the present embodiment, the light entrance surface 20a has an elongated shape. The lens sheet portion 34 is configured with prism lenses projecting toward the light guide plate 20 in a convex manner and each of the prism lenses has a cylinder axis extending in the long-side direction of the light entrance surface 20a. With this configuration, the light collecting member 38 diffuses light that is directed from the light collecting member 38 to the light entrance surface 20a. The light collecting member 38 diffuses the light in the thickness direction of the light guide plate 20, and accordingly the light from the LED unit 38 enters a broader area of the light entrance surface 20a.

In the present embodiment, the frame 14 and the backlight chassis 22 hold the LED unit 32 and the light guide plate 20. Furthermore, the board portion 36 is fitted to the fitting portions 40a and 40b on the backlight chassis 22 and the frame 14. Accordingly, the light collecting member 38 is fixed to the backlight chassis 22 and the frame 14. With this configuration, the light collecting member 38 is arranged stably.

### Second Embodiment

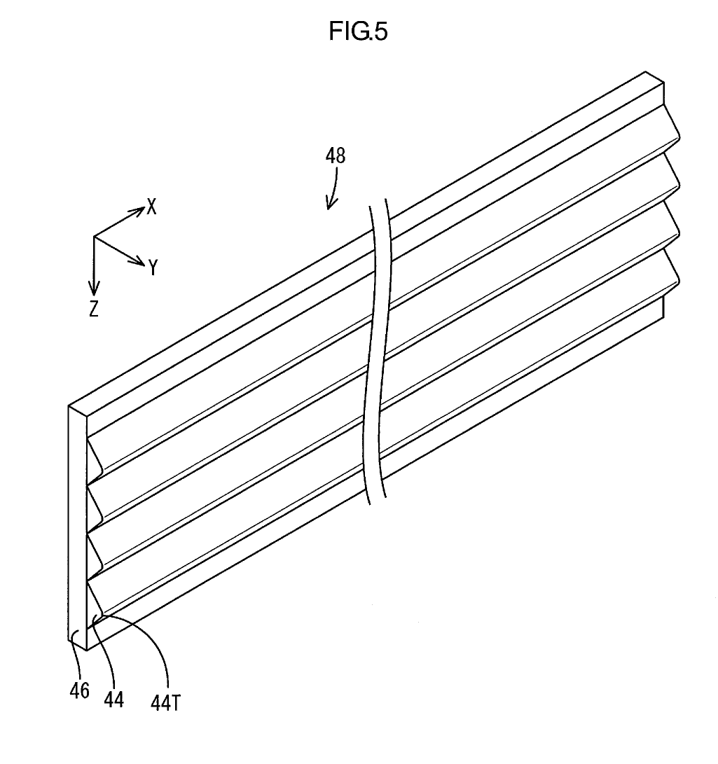

FIG. 5 illustrates an enlarged perspective view of a light collecting member 48 according to a second embodiment. The light collecting member 48 of the second embodiment includes a lens sheet portion 44 different in shape from the lens sheet portion of the first embodiment. The construction, operations and effects as same as the first embodiment will not be explained.

The light collecting member 48 of the second embodiment includes the lens sheet portion 44 that is configured with prism lenses each projecting toward the light guide plate in a convex manner. As illustrated in FIG. 5, the cylindrical axes of the prism lenses extend in the long-side direction of the light entrance surface of the light guide plate and a top portion 44T of each prism lens is curved. Therefore, if the surface of the lens sheet portion 44 comes in contact with the light entrance surface of the light guide plate due to vibration and the like, the light entrance surface is prevented from being damaged by the top portions 44T of the prism lenses.

### Third Embodiment

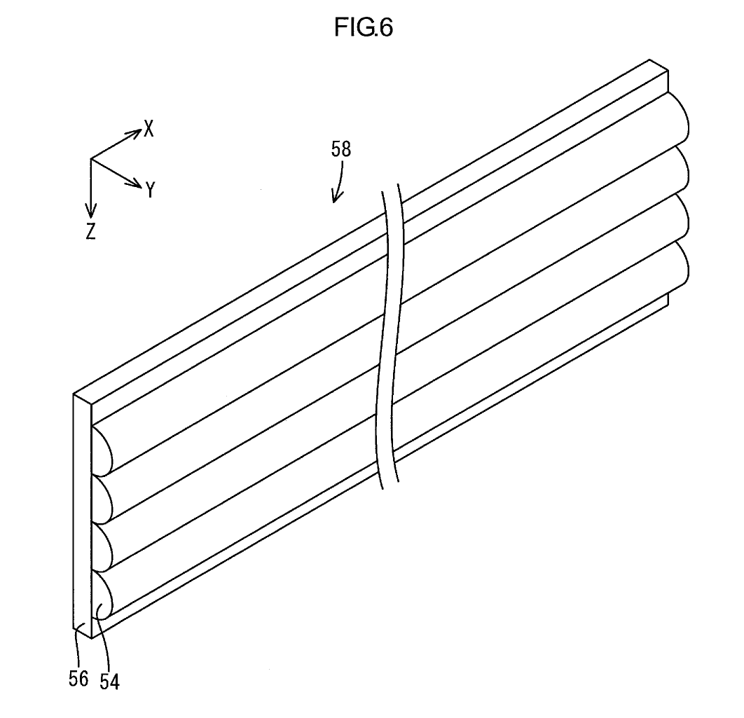

FIG. 6 illustrates an enlarged perspective view of a light collecting member 58 according to a third embodiment. The light collecting member 58 of the third embodiment includes a lens sheet portion 54 different in shape from the lens sheet portion of the first embodiment. The construction, operations and effects as same as the first embodiment will not be explained.

In the light collecting member 58 of the third embodiment, as illustrated in FIG. 6, the lens sheet portion 54 is configured with a lenticular lens projecting toward the light guide plate in a convex manner. A cylindrical axis of the lenticular lens extends in the long-side direction of the light entrance surface. With such a configuration, the light collecting member 58 diffuses light directed to the light entrance surface therefrom and the light collecting member 58 diffuses light in the thickness direction of the light guide plate, and therefore light from the LED unit is directed to a broader area of the light entrance surface.

### Fourth Embodiment

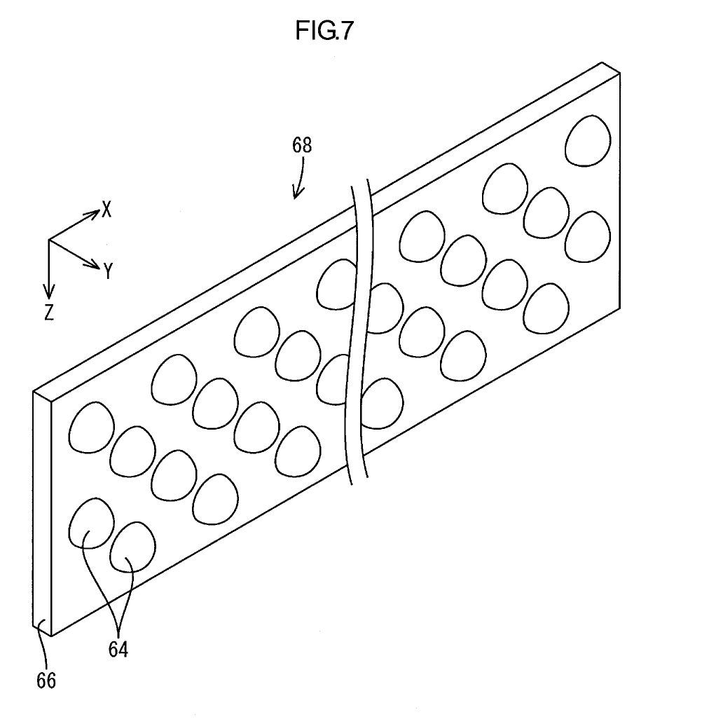

FIG. 7 illustrates an enlarged perspective view of a light collecting member 68 according to a fourth embodiment of the present invention. The light collecting member 68 of the fourth embodiment includes a lens sheet portion 64 different in shape from the lens sheet portion of the first embodiment. The construction, operations and effects as same as the first embodiment will not be explained.

In the light collecting member 68 of the fourth embodiment, the lens sheet portion 64 is configured with a lens array including a plurality of micro lenses. Accordingly, light exits from the micro lenses toward the light guide plate and therefore light from the LED unit is effectively directed to the light entrance surface. Furthermore, each micro lens is formed in a hemispherical shape so as to bulge out toward the light guide plate in a convex manner. Accordingly, light directed to the light entrance surface from the light collecting member 68 is diffused in a broad area.

### Fifth Embodiment

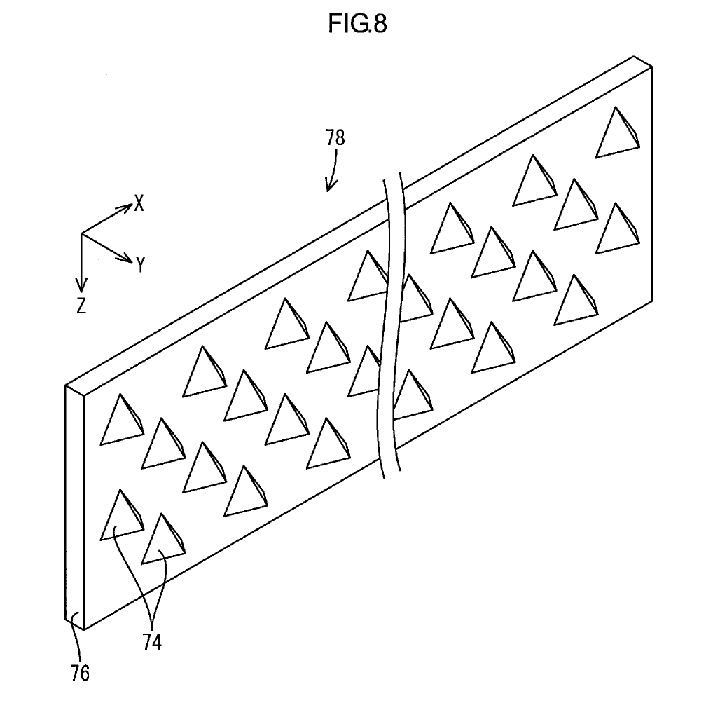

FIG. 8 illustrates an enlarged perspective view of a light collecting member 78 according to a fifth embodiment. The light collecting member 78 of the fifth embodiment includes a plurality of micro lenses in a lens sheet portion 74 different in shape from the micro lenses of the fourth embodiment. The construction, operations and effects as same as the first embodiment will not be explained.

The light collecting member 78 of the fifth embodiment includes a plurality of micro lenses and each of the micro lenses is formed in a triangular pyramid so as to project toward the light guide plate in a convex manner. With this configuration, the light from the LED unit substantially vertically enters the light entrance surface, and accordingly the light from the LED unit is likely to be totally reflected within the light guide plate.

### Sixth Embodiment

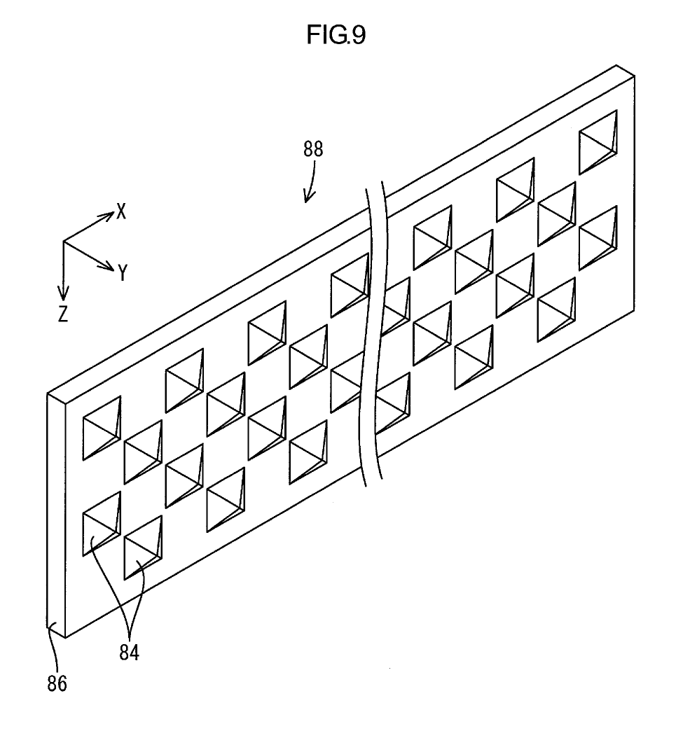

FIG. 9 illustrates an enlarged perspective view of a light collecting member 88 according to a sixth embodiment of the present invention. The light collecting member 88 of the sixth embodiment includes a plurality of micro lenses in a lens sheet portion 84 different in shape from the micro lenses of the fourth embodiment. The construction, operations and effects as same as the first embodiment will not be explained.

The light collecting member 88 of the sixth embodiment includes a plurality of micro lenses and each of the micro lenses is formed in a quadrangular pyramid so as to project toward the light guide plate in a convex manner. With the light collecting member 88, light from the LED unit substantially vertically enters the light entrance surface, and accordingly the light from the LED unit is likely to be totally reflected within the light guide plate.

### Seventh Embodiment

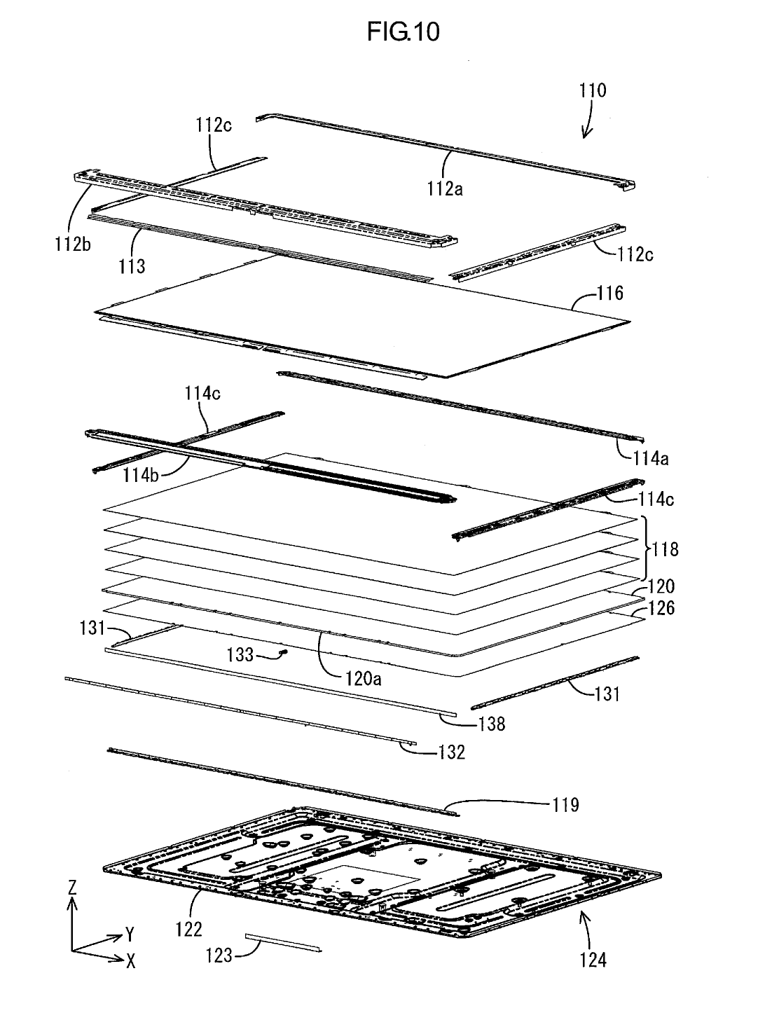

FIG. 10 illustrates an exploded perspective view of a liquid crystal display device 110 according to a seventh embodiment. An upper side in FIG. 10 corresponds to a front-surface side and a lower side in FIG. 10 corresponds to a rear-surface side. An entire shape of the liquid crystal display device 110 is a landscape rectangular. As illustrated in FIG. 10, the liquid crystal display device 110 includes a liquid crystal panel 116 as a display panel, and a backlight unit 124 as an external light source. The liquid crystal panel 116 and the backlight unit 124 are integrally held by a top bezel 112a, a bottom bezel 112b, side bezels 112c (hereinafter a bezel set 112a to 112c) and the like. The construction of the liquid crystal panel 116 that is as same as the first embodiment will not be explained.

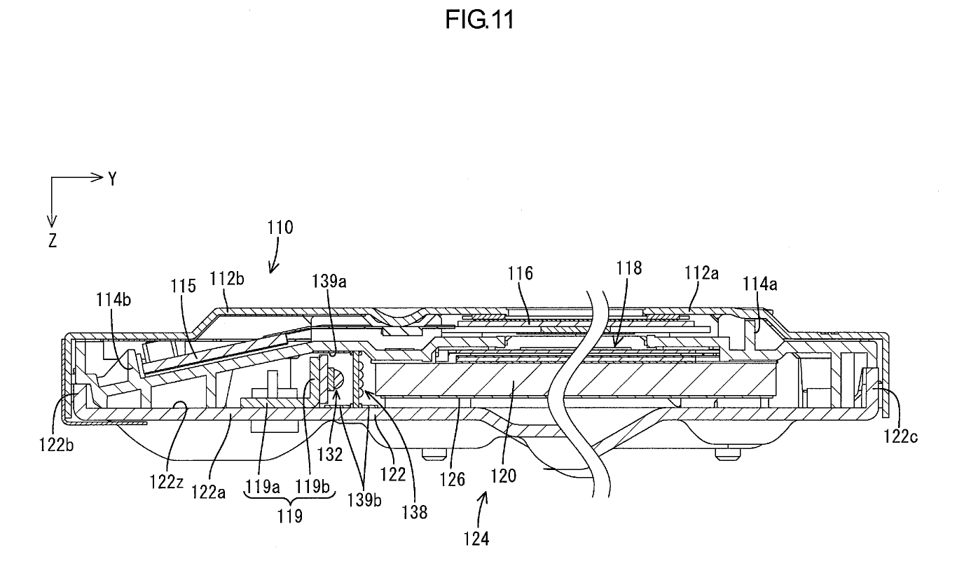

In the following, the backlight unit 124 will be explained. As illustrated in FIG. 10, the backlight unit 124 includes a backlight chassis 122, optical members 118, a top frame 114a, a bottom frame 114b, side frames 114c (hereinafter a frame set 114a to 114c) and a reflection sheet 126. The liquid crystal panel 116 is sandwiched between the bezel set 112a to 112c and the frame set 114a to 114c. A reference numeral 113 represents an insulating layer configured to insulate a driving circuit board 115 (see FIG. 11) for driving the liquid crystal panel 116. The substantially box-shaped backlight chassis 122 has an opening on the front-surface side (on the light exit side and the liquid crystal panel 116 side). The optical members 118 are provided on the front-surface side of the light guide plate 120. The reflection sheet 126 is provided on the rear-surface side of the light guide plate 120. Furthermore, the backlight chassis 122 houses a pair of cable holders 131, a light collecting member 138, a heat sink (mounting heat sink) 119, an LED unit 132 and the light guide plate 120 in the backlight chassis 122. The LED unit 132, the light guide plate 120 and the reflection sheet 134a are supported each other by a rubber bushing 133. A power supply circuit board (not shown) supplying power to the LED unit 132 and a protection cover 123 for protecting the power supply circuit board are mounted on the rear side of the backlight chassis 122. The pair of cable holders 131 is arranged in the short-side direction of the backlight chassis 122 and holds cables electrically connected between the LED unit 32 and the power supply circuit board. The light collecting member 138 is provided between the LED unit 132 and the light entrance surface 120a of the light guide plate 120 in the long-side direction of the light guide plate 120. The light collecting member 138 is configured to collect light that exits from the LED unit 132 and collect the light in the thickness direction of the light guide plate 120.

FIG. 11 illustrates a vertical sectional view of the backlight unit 124. As illustrated in FIG. 11, the backlight chassis 122 includes a bottom plate 122a having the bottom surface 122z thereon and side plates 122b and 122c, each of which rises shallowly from an outer edge of the corresponding side of the bottom plate 122a. The backlight chassis 122 supports at least the LED unit 132 and the light guide plate 120. Furthermore, the heat sink 119 includes a bottom surface portion 119a and a side surface portion 119b that rises from one of outer edges of the long side of the bottom surface portion 119a. The heat sink 119 is formed in an L-shape with a horizontal sectional view and provided in the direction along one of long sides of the backlight chassis 122. The bottom surface portion 119a of the heat sink 119 is fixed to the bottom plate 122a of the backlight chassis 122. The LED unit 132 extends in the direction along one long side of the backlight chassis 122. The LED unit 132 is fixed to the side surface portion 119b of the heat sink 119 such that the light exit side of the LED unit 132 faces the light entrance surface 120a of the light guide plate 120. Accordingly, the bottom plate 122a of the backlight chassis 122 supports the LED unit 132 through the heat sink 119. The heat sink 119 dissipates heat generated in the LED unit 132 outside the backlight unit 124 through the bottom plate 122a of the backlight chassis 122.

As illustrated in FIG. 11, the light guide plate 120 is provided between the light collecting member 138 and the side plate 122c of the backlight chassis. The frame set 114a to 114c and the backlight chassis 122 sandwich the LED unit 132, the light collecting member 138, the light guide plate 120 and the optical members 118. As illustrated in FIG. 11, the driving circuit board 115 is provided on the front-surface side of the bottom frame 114b. The driving circuit board 115 is electrically connected to the display panel 116 to supply image data and various control signals that are necessary to display images with the display panel 116. A reflection member 134a is provided on a part of the surface of the bottom frame 114b facing the LED unit 132 and extends in the long-side direction of the light guide plate 120. A reflection member 134b is provided on a part of the bottom surface 122z facing the LED unit 132 and extends in the long-side direction of the light guide plate 120.

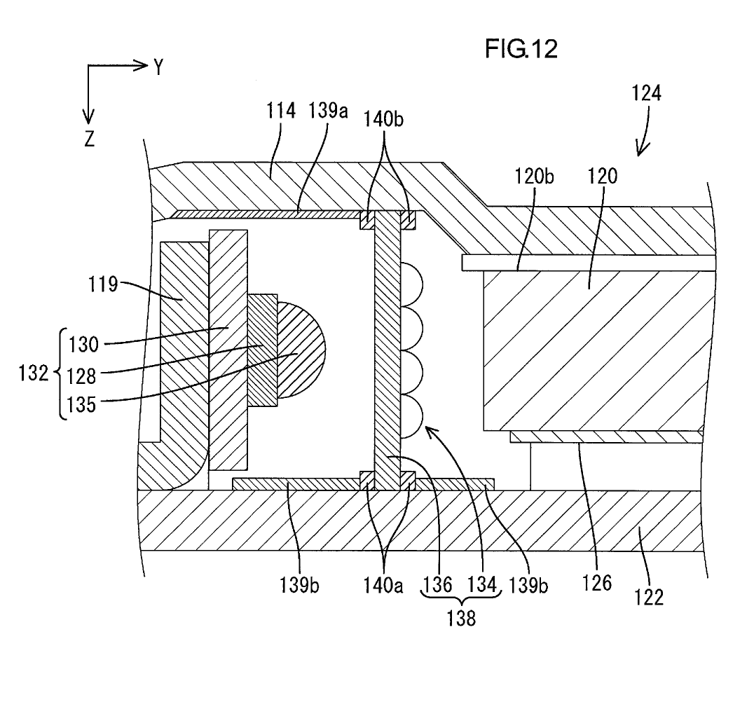

FIG. 12 illustrates an enlarged sectional view of a vicinity of the light collecting member 138 in FIG. 11. As illustrated in FIG. 12, the light collecting member 138 includes a board portion 136 that faces the LED unit 132 and a lens sheet portion 134 that faces the light entrance surface 120a. The board portion 136 and the lens sheet portion 134 are put together to be integrally formed as the light collecting member 138. The plate-shaped board portion 136 extends in the long-side direction (X-axis direction) of the light guide plate 120. An upper edge portion and a lower edge portion of the board portion 136 are fitted to fitting portions 140b and 140a, respectively. Each of the fitting portions 140b and 140a is provided on the surface of the frame 114 and the surface of the backlight chassis 122, respectively. The lens sheet portion 134 is configured with a lenticular lens projecting toward a light guide plate 120 in a convex manner.

In the LED unit 132, an LED light source 128 that is configured to emit white light is arranged on an LED board 130. The light emission side of the LED light source 128 is covered by a hemispherical lens member 135 that is curved toward the light entrance surface 120a in a convex manner.

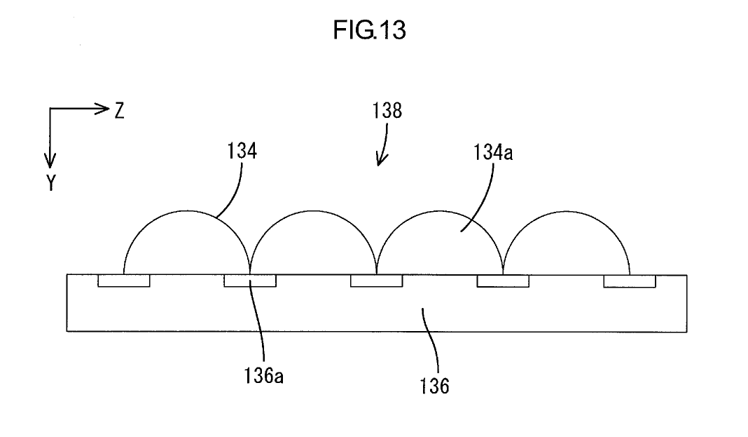

FIG. 13 illustrates an enlarged side view of the light collecting member 138. As illustrated in FIG. 13, the lens sheet portion 134 includes a plurality of lens portions 134a arranged on the light guide plate 120 side of the board portion 136. Light reflection portions 136a are provided between the board portion 136 and the lens sheet portion 134. The light reflection portions 136a are selectively arranged in boundaries of the two adjacent lens portions 134a. The light reflection portions 136a reflect light that enters the board portion 136 from the LED unit 132. With the above configuration, a part of the light exiting from the LED unit 132 toward the light collecting member 138 is reflected by the light reflection portions 136a of the board portion 136 and a part of the light passes through the board portion 136. Light reflected at the light reflection portions 136a is reflected by the reflection members 134a and 134b and directed to the light collecting member 138 again.

In the backlight unit of the present embodiment, the reflection members 134a and 134b are provided. With this configuration, light that is exited from the LED unit 132 and dispersed out of the light collecting member 138 is directed to the light collecting member 138 by the reflection members 134a and 134b. This improves the efficiency in directing light exiting from the LED unit 132 to the light collecting member 138. Furthermore, the hemispherical lens member 135 covers the light emission side of the LED light source 128. Accordingly, the lens member 135 spreads light emitted from the LED light source 128 in a broad area. Therefore, light is directed to an entire surface of the board portion 136 of the light collecting member 138 with uniform brightness.

In the backlight unit 124 of the present embodiment, the reflection members 138 are provided. Furthermore, in the board portion 136, the light reflection portions 136a are selectively arranged boundaries of the adjacent lens portions 134a. This allows all the light entering the light collecting member 138 to pass through the lens portions 134a to exit toward the light guide plate 120, thereby improving the collimation of light exiting from the light collecting member 138.

Correspondence relationships between the construction of the embodiments and the construction of the present invention will be described. The LED light sources 28, 46, 68 and 88 are an example of a “light source.” The backlight units 24 and 84 are an example of a “lighting device.” The LED boards 30, 50, 70, 90 are an example of a “light source board.”

In the following, modifications of the above embodiments will be explained.

(1) In the above embodiments, the LED light source configured to emit white light is mounted. However, three types of LED light sources such as emitting red light, green light and blue light, may be mounted on a plane. A combination of an LED light source configured to emit blue light and a yellow fluorescent material may be mounted. A linear light source such as a cold cathode tube may be used.

(2) In the above embodiments, the board portion of the light collecting member is fitted to the fitting portions provided in the frame and the backlight chassis. However, the method of fixing the light collecting member to the holding members may be altered.

(3) The light collecting member may collect light from the light source in the thickness direction of the light guide plate. The shape of the light collecting member may be altered.

(4) In the above embodiments, the liquid crystal display device including the liquid crystal panel as a display panel. The technology can be applied to display devices including other types of display components.

(5) In the above embodiments, the television receiver including the tuner is used. However, the technology can be applied to a display device without a tuner.

The embodiments of the present invention have been described in detail. The embodiments are for illustrative purposes only and by no means limit the scope of the present invention. Technologies described in the present invention include variations and modifications of the embodiments and examples described above.

The technical elements described or shown in the specification or drawings exhibit the technical usefulness individually or in various combinations thereof. The technical elements are not limited to the combinations defined in the claims at the time of filing the application. Furthermore, the technologies illustrated in the specification or drawings realize a plurality of purposes at the same time and have a technical usefulness when one of the purposes is realized.

### EXPLANATION OF SYMBOLS

TV: television receiver, Ca, Cb: cabinet, T: tuner, S: stand, 10, 110: liquid crystal display device, 12: bezel, 14: frame, 16, 116: liquid crystal panel, 18, 118: optical members, 18a: diffuser plate, 18b: diffuser sheet, 18c: lens sheet, 18d: reflecting type polarizing sheet, 20, 70, 120: light guide plate, 20a, 70a, 120a: light entrance surface, 20b: light exit surface, 20c: opposite surface, 20d: surface that is opposite to the light entrance surface, 22, 72, 122: backlight chassis, 22a, 72a, 122a: bottom plate, 24, 74, 124: backlight unit, 26, 76, 126: reflection sheet, 28, 78, 128: LED light source, 30, 80, 130: LED board, 32, 82, 132: LED unit, 34, 44, 54, 64, 74, 84, 134: lens sheet portion, 36, 46, 56, 66, 76, 86, 136: board portion, 38, 48, 58, 68, 78, 88, 138: light collecting member, 112a: top bezel, 112b: bottom bezel, 112c: side bezel,113: insulating layer, 114a: top frame, 114b: bottom frame, 114c: side frame, 115: driving circuit board, 119: heat sink, 119a: bottom surface portion, 119b: side surface portion, 123: protection cover, 131: cable holder, 134a: lens portion, 135: lens member, 136a: light reflection portion, 139a, 139b: reflection member

1. A lighting device comprising:
a light source;
a light guide plate having a light entrance surface on a side surface thereof; and
a light collecting member provided between the light source and the light entrance surface and configured to collect light from the light source in a thickness direction of the light guide plate.

2. The lighting device according to claim 1, wherein:
the light guide plate has a light exit surface and an opposite surface, and the light exiting from the light source and entering the light entrance surface is exited through the light exit surface and the opposite surface is a surface of the light guide plate oppose to the light exit surface; and
the light collecting member collects light such that light collected by the light collecting member and entering the light guide plate from the light entrance surface totally reflects off an interface between the light exit surface and another part or an interface between the opposite surface and an outside.

3. The lighting device according to claim 1, wherein:
the light collecting member includes a board and a lens sheet portion, and the board has a light transmission property and is formed in a plate shape and provided to face the light source, and the lens sheet portion is configured by a lens sheet and faces the light entrance surface.

4. The lighting device according to claim 3, wherein:
the light entrance surface is formed in an elongated shape;
the lens sheet portion is configured with a lenticular lens projecting toward the light guide plate in a convex manner; and
the lenticular lens has a cylindrical axis extending in a long side direction of the light entrance surface.

5. The lighting device according to claim 3, wherein:
the light entrance surface is formed in an elongated shape;
the lens sheet portion is configured with a prism lens projecting toward the light guide plate in a convex manner; and
the prism lens has a cylindrical axis extending in a long side direction of the light entrance surface.

6. The lighting device according to claim 5, wherein the prism lens has a curved top end portion.

7. The lighting device according to claim 3, wherein the lens sheet portion is configured with a lens array including a plurality of micro lenses each projecting toward the light guide plate in a convex manner.

8. The lighting device according to claim 7, wherein each of the micro lenses is formed in a pyramid shape.

9. The lighting device according to claim 7, wherein each of the micro lenses is formed in a hemispherical shape such that each of the micro lenses is curved in the convex manner so as to project toward the light guide plate.

10. The lighting device according to claim 3, further comprising a holding member configured to hold at least the light source and the light guide plate, the holding member including a fitting portion extending in the long side direction of the light entrance surface, to which the board is fitted, wherein:
the light collecting member is fixed by the holding member by fitting of the board to the fitting portion.

11. The lighting device according to claim 10, further comprising a reflection member provided between the light source and the light guide plate, wherein:
the light entrance surface is formed in an elongated shape and the reflection member extends in a long side direction of the light entrance surface.

12. The lighting device according to claim 11, wherein:
the lens sheet portion includes a plurality of lens portions provided on a surface of the board close to the light guide plate; and
the light collecting member further includes a light reflection portion provided between the board and the lens portion, and the light reflection portion is selectively arranged in a boundary portion between adjacent lens portions.

13. The lighting device according to claim 1, further comprising a lens member covering a light emission side of the light source, wherein:
the light source is a planer light source; and
the lens member is formed in a hemispherical shape so as to be curved projecting toward the light collecting member in a convex manner.

14. A display device comprising:
the lighting device according to claim 1; and
a display panel configured to provide display using light from the lighting device.

15. The display device according to claim 14, wherein the display panel is a liquid crystal panel using liquid crystals filled between base boards.

16. A television receiver comprising the display device according to claim 14.
